(19) United States
(12) Patent Application Publication
(10) Pub. No.: US 2005/0150403 A1
(43) Pub. Date: Jul. 14, 2005

(54) Cleaner-less image forming apparatus with electrifying device using an oscillating voltage

(75) Inventor: Hiroyuki Kidaka, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/505,868

(22) PCT Filed: Mar. 5, 2003
(86) PCT No.: PCT/JP03/02541

(30) Foreign Application Priority Data
Mar. 5, 2002 (JP) 2002-058540

(51) Int. Cl. B41F 5/00

(52) U.S. Cl. 101/212

(57) ABSTRACT

The present invention provides an image forming apparatus comprising an image bearing member for bearing an electrostatic image, an electrifying member for contacting with the image bearing member to electrify the image bearing member, voltage applying means for applying oscillation voltage to the electrifying member, image forming means for forming an electrostatic image on the image beating member electrified by the electrifying member, developing means for developing the electrostatic image on the image bearing member with toner to form a toner image, and transferring means for transferring the toner image on the image bearing member onto a transferring material, and wherein transferring residual toner on the image bearing member is recovered by the developing means after the toner is passed through an electrifying portion for the electrifying member and, regarding the oscillation voltage applied by the voltage applying means, a time required for shifting from an electrifying polarity side peak to a reverse side peak is longer than a time required for shifting the reverse side peak to the electrifying polarity side peak.

### TECHNICAL FIELD

The present invention relates to an image forming apparatus in which an exclusive cleaner for cleaning residual toner after transferring, and more particularly it relates to an image forming apparatus of contact electrifying type.

### BACKGROUND ART

In the past, an image forming apparatus of transferring type utilizing an electro-photographic process, such as a copying machine, a printer, a facsimile and the like, was constituted by a photosensitive member as an image bearing member which is generally of rotary drum type, an electrifying apparatus (electrifying process) for uniformly electrifying the photosensitive member with predetermined polarity and potential, an exposing apparatus (exposing process) as information writing means for forming an electrostatic latent image on the electrified photosensitive member, a developing apparatus (developing process) for visualizing the electrostatic latent image formed on the photosensitive member with toner as developer to form a toner image, a transferring apparatus (transferring process) for transferring the toner image from a surface of the photosensitive member onto a transferring material as a recording medium such as a paper sheet, a cleaning apparatus (cleaning process) for removing the toner remaining on the photosensitive member more or less after the transferring process to clean the surface of the photosensitive member, and a fixing apparatus (fixing process) for fixing the toner image onto the transferring material, and the electro-photographic process (electrifying, exposing, developing, transferring and cleaning) was applied to the photosensitive member repeatedly to perform image formation.

Although the residual toner remaining on the photosensitive member after the transferring process is removed from the surface of the photosensitive member by the cleaning apparatus to form waste toner accumulated within the cleaning apparatus, it is desirable that such waste toner does not leak in consideration of preservation of environment and/or effective reuse of resources.

To this end, there has been proposed an image forming apparatus cleaner-less type in which transferring residual toner to be recovered by a cleaning apparatus is recovered by a developing apparatus to be used as developing toner again.

Cleaning simultaneous with developing is a method in which the transferring residual toner remaining on a portion (non-image portion) of the surface of the photosensitive drum (which portion should not be developed with toner) after the transferring is recovered by means of the developing apparatus by fog removing bias (fog removing potential difference Vback as potential difference between DC voltage to be applied to the developing apparatus and surface potential of the photosensitive member) during a developing process in next image formation, i.e. during a developing process for a next electrostatic latent image after the photosensitive member is subsequently electrified and exposed to form such an electrostatic latent image. According to this method, since the transferring residual toner is recovered by the developing apparatus and is reused for developing the electrostatic latent image in the next process and so on, the waste toner can be eliminated and maintenance can be facilitated. Further, because of cleaner-less, the image forming apparatus can be made more compact.

In the image forming apparatus of cleaner-less type in which the transferring residual toner remaining on the photosensitive drum after the transferring process is removed and recovered by the cleaning simultaneous developing by means of the developing apparatus and is reused, in a case where the electrifying apparatus is an electrifying apparatus of contact type in which a contact electrifying member abuts against the photosensitive member to electrify the surface of the photosensitive drum by oscillation voltage, if electrifying polarity of the toner when the transferring residual toner on the photosensitive drum is passed through a contact nip portion between the photosensitive drum and the contact electrifying member and brought to a developing portion is not normal polarity recoverable in the developing portion and an electrified amount of the toner is not a toner electrified amount capable of developing the electrostatic latent image formed on the photosensitive member by means of the developing apparatus, a fog phenomenon and/or fusing of the toner to the photosensitive member will occur, thereby causing a poor image.

That is to say, when the electrifying apparatus is the electrifying apparatus of contact type in which the surface of the photosensitive member is electrified by the oscillation voltage, the toner passed through an electrifying portion as the contact nip portion between the photosensitive member and the contact electrifying member includes toner having normal electrifying polarity, toner (referred to as “reversal toner” herein after) having polarity opposite to the normal polarity and toner in which the electrified amount is reduced due to removal of electricity. Among them, the reversal toner and the toner having less electrified amount are not recovered at the developing portion and are easily entrained by the photosensitive member.

Further, due the recent variety of user needs, since a large amount of transferring residual toner is generated in a continuous printing operation for images having high coverage rate such as photographic images and in a multi-developing system regarding the photosensitive member due to colorization, the above-mentioned problem is further promoted.

### DISCLOSURE OF THE INVENTION

An object of the present invention is to provide an image forming apparatus using a contact electrifying system, in which uniformity of electrifying potential becomes high by applying oscillation voltage.

Another object of the present invention is to provide an image forming apparatus in which, regardless of overlapping of alternating voltage, electrifying polarity of transferring residual toner on an image bearing member passed through a contact electrifying member and brought to a developing portion can be coincided with normal polarity recoverable at the developing portion.

A further object of the present invention is to provide an image forming apparatus comprising an image bearing member for bearing an electrostatic image, an electrifying member for contacting with the image bearing member to electrify the image bearing member, voltage applying means for applying oscillation voltage to the electrifying member, image forming means for forming an electrostatic image on the image bearing member electrified by the electrifying member, developing means for developing the electrostatic image on the image bearing member with toner to form a toner image, and transferring means for transferring the toner image on the image bearing member onto a transferring material, and wherein transferring residual toner on the image bearing member is recovered by the developing means after the toner is passed through an electrifying portion for the electrifying member and, regarding the oscillation voltage applied by the voltage applying means, a time required for shifting from a electrifying polarity side peak to a reverse side peak is longer than a time required for shifting the reverse side peak to the electrifying polarity side peak.

The other objects of the present invention will be apparent from the following detailed explanation.

### BRIEF DESCRIPTION OF THE DRAWINGS

FIG. 1 is a schematic constructional view of an image forming apparatus according to an embodiment of the present invention;

FIG. 2 is a schematic view showing layer constructions of a photosensitive drum and an electrifying roller;

FIG. 3 is a wave form view of alternating voltage used in an embodiment 1 of the present invention;

FIG. 4 is a wave form view of alternating voltage in contrast with the alternating voltage used in the embodiment 1;

FIG. 5 is a wave form view of alternating voltage in contrast with the alternating voltage used in the embodiment 1;

FIG. 6 is a wave form view of alternating voltage used in an embodiment 2 of the present invention;

FIG. 7 is a wave form view of another alternating voltage used in an electrifying apparatus;

FIG. 8 is a wave form view of other alternating voltage used in the electrifying apparatus; and

FIGS. 9A and 9B are schematic views showing an alteration of an electrifying member.

### BEST MODE FOR CARRYING OUT THE INVENTION

The present invention will now be explained in connection with preferred embodiments thereof with reference to the accompanying drawings.

### EMBODIMENT 1

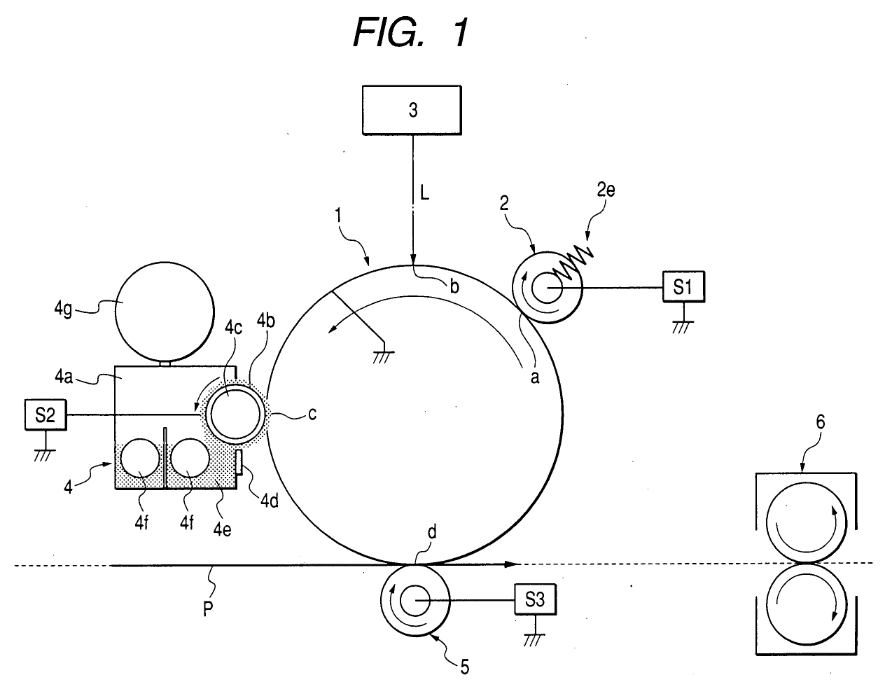

FIG. 1 is a schematic constructional view showing an example of an image forming apparatus according to the present invention. The image forming apparatus according to this embodiment is a laser beam printer of contact electrifying, reversal developing and cleaner-less type utilizing a transferring type electro-photographic process, in which a maximum paper passing size is an A3 size.
(1) Entire schematic construction of printer
a) Image bearing member

An image bearing member is embodied as an electro-photographic photosensitive member 1 of rotary drum type (referred to as “photosensitive drum” hereinafter). The photosensitive drum 1 is a negative polarity organic photo-conductor (OPC) having an outer diameter of 50 mm and is rotatingly driven in an anti-clockwise direction shown by the arrow around a center shaft at a process speed (peripheral speed) of 100 mm/sec.

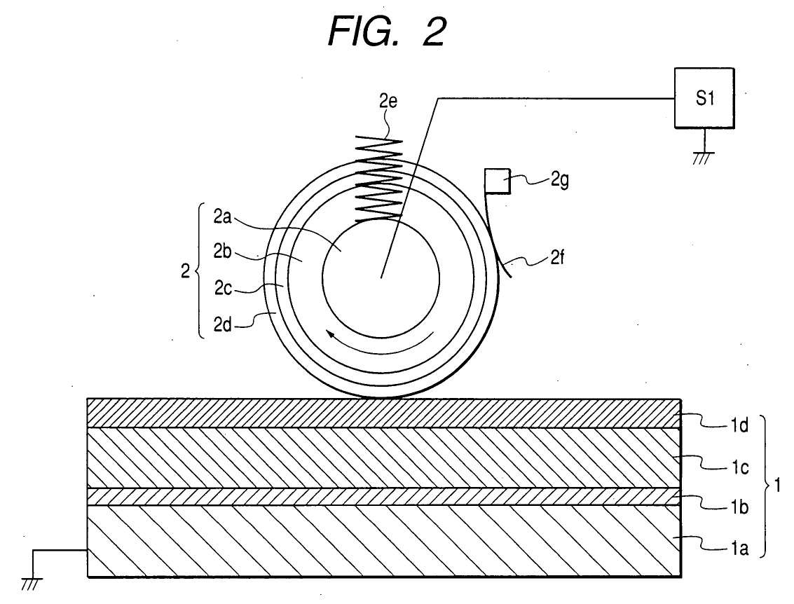

As shown in a schematic layer construction of FIG. 2, the photosensitive drum 1 is constituted by coating an undercoating layer 1b for suppressing interference of light and for enhancing adhering ability of an upper layer, a photo-charge generating layer 1c and a charge transporting layer 1d, in order from an underside, on a surface of an aluminum cylinder (conductive drum substrate) 1a.
b) Electrifying means

An electrifying apparatus 2 of contact type (contact electrifier) serves to uniformly electrify a peripheral surface of the photosensitive drum 1 and is an electrifying roller (roller electrifier) in this example.

In the electrifying roller 2, both ends of a metal core 2a thereof are rotatably supported by bearing members (not shown), and the roller is biased toward the photosensitive drum by a pressurizing spring 2e to abut the roller against the surface of the photosensitive drum 1 with a predetermined urging force, so that the roller is driven in synchronous with a rotation of the photosensitive drum 1. An abutment portion between the photosensitive drum 1 and the electrifying roller 2 defines an electrifying portion (electrifying nip portion) a.

By applying oscillation voltage obtained by overlapping alternating voltage with DC voltage to the metal core 2a of the electrifying roller 2 from a power supply device S1, the surface of the rotating photosensitive drum 1 is uniformly electrified with predetermined polarity and potential. Here, the alternating voltage means all of voltages in which amplitude is varied with a time, such as a since wave, a rectangular wave, a triangular wave and the like.

A longitudinal length of the electrifying roller 2 is 320 mm and, as shown in the schematic layer construction of FIG. 2, has a three-layer construction consisting of an under layer 2b, an intermediate layer 2c and a surface layer 2d laminated, in order from an underside, around a metal core (support member) 2a. The under layer 2b is a foam sponge layer for reducing electrifying noise, and the surface layer 2s is a protection layer provided for preventing leak even if there is defect such as pinhole in the photosensitive drum 1.

More specifically, specification of the electrifying roller 2 in this embodiment is as follows:
a. Metal core: a round rod made of a stainless steel and having a diameter of 6 mm
b. Under layer 2b: made of foam EPDM dispersing carbon therein and having specific weight of 0.5 g/cm³, volume resistive value of 10² to 10⁹ Ω cm, layer thickness of 3.0 mm and length of 320 mm
c. intermediate layer 2c: made of NBR group rubber dispersing carbon therein and having volume resistive value of 10² to 10⁵ Ω cm and layer thickness of 700 μm
d. surface layer 2d: made by dispersing tin oxide and carbon in threzine resin of fluorine compound and having volume resistive value of 10⁷ to 10¹⁰Ω cm, surface roughness of (JIS Standard 10 point average surface roughness Ra) of 1.5 μm and layer thickness of 10 μm.

In FIG. 2, an electrifying roller cleaning member 2f is formed from a flexible cleaning film in this example. The cleaning film 2f is disposed in parallel with a longitudinal direction of the electrifying roller 2 and is connected at its one end to a support member 2g reciprocally shifted by a predetermined amount along such a longitudinal direction and cooperates with the electrifying roller 2 to define a contact nip in the vicinity of a free end thereof.

When the support member 2g is reciprocally shifted by the predetermined amount in the longitudinal direction by a drive motor of the printer via a gear train, the cleaning film 2f is frictionally contacted with the surface layer 2d of the electrifying roller. As a result, contaminant (fine powder toner, externally added agent and the like) adhered to the surface layer 2d of the electrifying roller is removed.
c) Information writing means

An exposing apparatus 3 is information writing means for forming an electrostatic latent image on the electrified surface of the photosensitive drum 1. In this embodiment, the exposing means is a laser beam scanner using a semiconductor laser. The exposing apparatus outputs a laser beam modulated in response to an image signal sent to the printer from a processing host such as an image reading device (not shown) to perform laser scanning exposure L (image exposure) at an exposing position b with respect to the uniformly electrified surface of the rotating photosensitive drum 1.

By such laser scanning exposure, potential of a portion of the surface of the photosensitive drum 1 which is illuminated by the laser beam is reduced, with the result that the electrostatic latent image corresponding to the scanning-exposed image information is formed on the surface of the rotating photosensitive drum 1.
d) Developing means

A developing apparatus (developing means) 4 is developing means for visualizing the electrostatic latent image by supplying developer (toner) to the electrostatic latent image on the photosensitive drum 1. In this embodiment, a reversal developing apparatus of two-component, magnetic brush developing type is used.

The developing apparatus includes a developing container 4a and a developing sleeve 4b. The developing sleeve 4b is rotatably disposed within the developing container 4a so that a portion of the sleeve is exposed externally. The developing apparatus further includes a magnet roller 4c inserted into the developing sleeve 4b and non-rotatably fixed, a developer coating blade 4d, two-component developer 4e contained in the developing container 4a, developer agitating members 4f disposed within the developing container 4a in the vicinity of a bottom thereof, and a toner hopper 4g for containing toner to be replenished.

The two-component developer 4e in the developing container 4a is a mixture of toner and magnetic carrier and is agitated by the developer agitating members 4f. In this embodiment, resistance of the magnetic carrier is about 10¹³ Ω cm and a particle diameter is 40 μm. The toner is tribo-electrically charged or electrified with negative polarity by frictional contact between the toner and the magnetic carrier.

The developing sleeve 4b is opposed to the photosensitive drum 1 and is disposed adjacent to the drum with a predetermined gap (referred to as “S-D gap” hereinafter) of 350 μm therebetween. A portion where the photosensitive drum 1 is opposed to the developing sleeve 4b defines a developing portion c.

At the developing portion c, the developing sleeve 4b is rotatingly driven in a direction opposite to an advancing direction of the photosensitive drum 1. A part of the two-component developer 4e in the developing container 4a is absorbed and held on an outer peripheral surface of the developing sleeve 4b by a magnetic force of the magnet roller 4c disposed within the sleeve to form a magnet brush layer. The magnet brush layer is rotatingly conveyed by a rotation of the sleeve and is adjusted to a predetermined thin layer by the developer coating blade 4d so that the layer is frictionally contacted with the surface of the photosensitive drum 1 moderately at the developing portion c.

Predetermined developing bias is applied to the developing sleeve 4b from a power supply S2. In this embodiment, the developing bias voltage to the developing sleeve is oscillation voltage obtained by overlapping DC voltage (Vdc) with alternating voltage (Vac) and, more specifically, oscillation voltage obtained by overlapping DC voltage of −350 V with alternating voltage of 1,600 V.

A toner component in the developer coated on the surface of the developing sleeve 4b and conveyed to the developing portion c is selectively adhered onto the surface of the photosensitive drum 1 in correspondence to the electrostatic latent image by a magnetic field due to the developing bias, thereby developing the electrostatic latent image as a toner image. In this embodiment, the toner is adhered to an exposure bright portion of the surface of the photosensitive drum 1, thereby reversal-developing the electrostatic latent image.

In this case, an electrified amount of the toner developed on the photosensitive drum is −25 μC/g.

The developer thin layer born on the developing sleeve 4b and passed through the developing portion c is returned to a developer reservoir in the developing container 4a as the developing sleeve is further rotated.

In order to maintain toner density of the two-component developer 4e in the developing container 4a to a predetermined substantially constant range, the toner density of the two-component developer 4e in the developing container 4a is detected, for example, by an optical toner density sensor (not shown), and, driving of the toner hopper 4g is controlled on the basis of detection information, with the result that the toner in the toner hopper 4g is replenished onto the two-component developer 4e in the developing container 4a. The toner replenished onto the two-component developer 4e is agitated by the agitating members 4f.
e) Transferring means and fixing means

In this embodiment, a transferring apparatus 5 is embodied as a transferring roller. The transferring roller 5 abuts against the photosensitive drum 1 with a predetermined urging force, and an abutment nip portion between the transferring roller and the photosensitive drum defines a transferring portion d. A transferring material (transferred member or recording material) P as a recording medium is fed to the transferring portion d at a predetermined control timing from a sheet feeding mechanism (not shown).

The transferring material P fed to the transferring portion d is pinched between the rotating photosensitive drum 1 and the transferring roller 5 and is conveyed thereby; meanwhile, by applying transferring bias (of +2 kV in this embodiment) having positive polarity opposite to negative polarity (normal electrifying polarity) of the toner to the transferring roller 5 from a power supply S3, the toner image on the photosensitive drum 1 is electrostatically transferred onto the surface of the transferring material P pinched and conveyed through the transferring portion d.

The transferring material P to which the toner image was transferred at the transferring portion d is separated from the surface of the photosensitive drum 1 and is conveyed to a fixing apparatus (for example, heat roller fixing apparatus) 6, where the image is fixed and the transferring material is outputted as a image formed matter (print or copy).
f) Cleaner-less system

The printer according to this embodiment is of cleaner-less type which does not include an exclusive cleaning apparatus for removing the transferring residual toner remaining more or less on the surface of the photosensitive drum 1 after the toner image is transferred to the transferring material P.

The transferring residual toner remaining on the surface of the photosensitive drum 1 after the transferring is brought to the developing portion c through the electrifying portion a and the exposing portion b as the photosensitive drum 1 is further rotated. In the developing portion, the residual toner is subjected to cleaning (recovering) simultaneous with developing by the developing apparatus 3 (cleaner-less system).

In the illustrated embodiment, as mentioned above, the developing sleeve 4b of the developing apparatus 4 is rotated in the direction opposite to the advancing direction of the surface of the photosensitive drum 1 at the developing portion c, which is advantage for recovering the transferring residual toner on the photosensitive drum 1.

Since the transferring residual toner on the surface of the photosensitive drum 1 passes through the exposing portion b, although the exposing process is performed on the transferring residual toner, since the amount of the transferring residual toner is relatively little, there is no great influence affecting upon the exposing process.
(2) Toner electrifying amount control

However, as mentioned above, when the electrifying roller 2 is the contact electrifying apparatus for electrifying the surface of the photosensitive drum 1 by the oscillation voltage, since the transferring residual toner passed through the contact nip portion a between the surface of the photosensitive drum 1 and the electrifying roller 2 includes the toner having normal electrifying polarity, the toner (reversal toner) having polarity opposite to the normal polarity and the toner in which the electrified amount is reduced, in order to perform the cleaning simultaneous developing of the transferring residual toner on the surface of the photosensitive drum 1 by means of the developing apparatus 4, it is necessary that the electrifying polarity of the transferring residual toner brought to the developing portion c and remaining on the surface of the photosensitive drum 1 is the normal polarity and the electrified amount thereof is the toner electrified amount capable of developing the electrostatic latent image on the surface of the photosensitive drum 1 by means of the developing apparatus 4. The reversal toner and the toner having the improper electrified amount cannot be removed and recovered from the surface of the photosensitive drum 1 by the developing apparatus 4, thereby causing the poor image.

Further, due to the recent variety of user needs, since a large amount of transferring residual toner is generated at once in a continuous printing operation for images having high coverage rate such as photographic images, the above-mentioned problem is further promoted.

To avoid this, in the illustrated embodiment, as mentioned above, the alternating voltage component of the oscillation voltage obtained by overlapping the DV voltage with the alternating voltage and applied to the electrifying roller 2 as the contact electrifying member is voltage satisfying the following conditions at least for a predetermined time:
Tup>Tdown
Where, Tup is a time from a peak of amplitude of the wave form of the alternating voltage at an electrifying polarity direction side to a peak of amplitude of the wave form of the alternating voltage at an electrifying polarity reverse direction side, and Tdown is a time from the peak of the amplitude of the wave form of the alternating voltage at the electrifying polarity reverse direction side to the peak of the amplitude of the wave form of the alternating voltage at the electrifying polarity direction side.

That is to say, voltage in which, regarding the wave form of the alternating voltage, the time Tup from the peak of the amplitude at the electrifying polarity direction side to the peak of the amplitude at the electrifying polarity reverse direction side is longer than the Tdown from the peak of the amplitude at the electrifying polarity reverse direction side to the peak of the amplitude at the electrifying polarity direction side is used as the electrifying voltage applied to the electrifying roller 2.

Although dependency of the wave form of the alternating voltage upon the toner electrified amount is not evident, it is guessed that a time and a rising angle from the peak of certain amplitude of the voltage wave form to the peak of the other amplitude changes time distribution of discharging and affects an influence upon the toner electrified amount.

Now, various embodiments in which a configuration of the wave of the alternating voltage is changed will be explained.

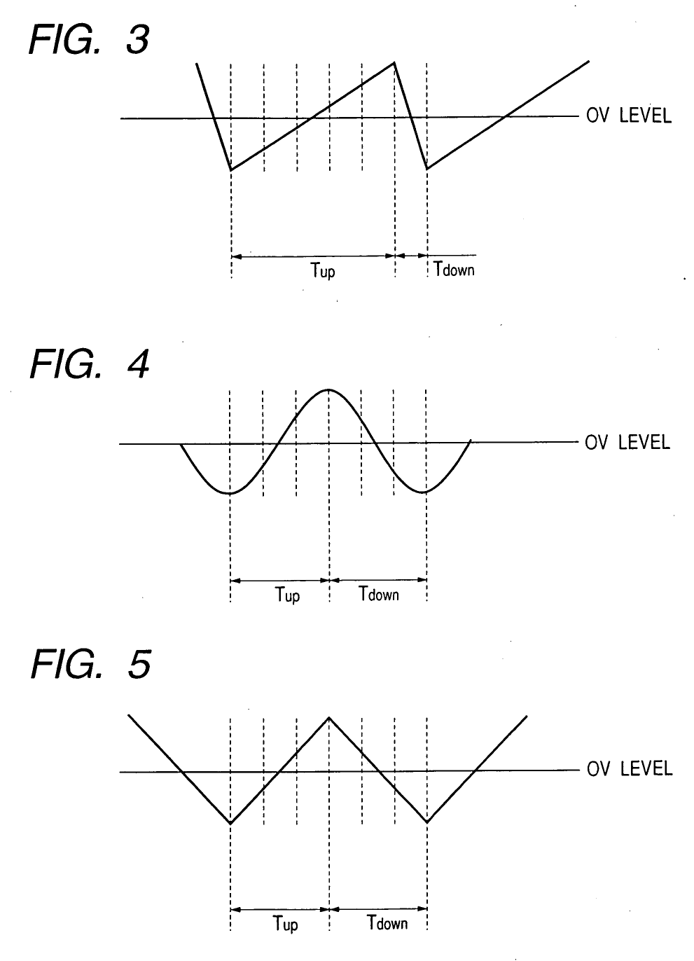

FIG. 3 is a wave form view showing alternating voltage used in this embodiment 1, where the wave form is a triangular wave form having amplitude of 1,600 V and frequency of 1,150 Hz. The wave of the alternating voltage has a duty ratio (pulse width τ/period T) of 50% and is linearly increased with certain inclination from the peak of the amplitude at the electrifying polarity direction side toward the peak of the amplitude at the electrifying polarity reverse direction side for a time corresponding to ⅚ of a wavelength, and such inclination is constant. This time is greater, by 5 times, than a time (corresponding to ⅙ of the wavelength) required for returning from the peak of the amplitude at the electrifying polarity reverse direction side to the peak of the amplitude at the electrifying polarity direction side. A rotational speed of the photosensitive drum is 100 mm/sec.

Regarding this wave, since the time Tup required for reaching the peak of the amplitude at the electrifying polarity reverse direction side from the peak of the amplitude at the electrifying polarity direction side is longer than the time Tdown required for returning to the peak of the amplitude at the electrifying polarity direction side from the peak of the amplitude at the electrifying polarity reverse direction side, the inclination of the rising portion at the electrifying polarity direction side becomes steep and the inclination of the rising portion at the electrifying polarity reverse direction side, with the result that, upon electrifying, the toner having the normal polarity due to the discharging at the electrifying polarity direction side is increased and occurrence of the reversal toner and the toner having improper charged amount (less charged amount) due to the discharging at the electrifying polarity reverse direction side are reduced.

Here, a relationship between the alternating voltage wave form of the electrifying voltage applied to the electrifying roller and the electrified amount of the toner after passed through the electrifying roller 2 is shown in the following Table 1:

TABLE 1

| A | B | C | D | E |
|---|---|---|---|---|
| 100 mm/sec | 1,600 V | 1,150 Hz | Embodiment 1 | −20 μC/g |
| 100 mm/sec | 1,600 V | 1,150 Hz | Rec. wave | −5 μC/g |
| 100 mm/sec | 1,600 V | 1,150 Hz | Trian. Wave | −5 μC/g |

Where A is a drum rotational speed, B is amplitude, C is frequency, D is a wave form, E is an average electrified amount, “Rec.” is Rectangular and “Trian.” is Triangular.

When the above-mentioned alternating voltage wave form is applied, toner electrified amount distribution becomes sharp distribution of −20 μC/g, and the reversal toner, and distribution of the toner having less electrified amount is not found.

Comparing this values with values in cases where alternating voltages having a sine wave (FIG. 4) and a triangular wave (FIG. 5) having the same amplitude and the same frequency, in which the time Tup required when the wave form reaches the peak of the amplitude at the electrifying polarity reverse direction side from the peak of the amplitude at the electrifying polarity direction side is the same as the time Tdown required when the wave form is returned to the peak of the amplitude at the electrifying polarity direction side from the peak of the amplitude at the electrifying polarity reverse direction side, when the sine wave shown in FIG. 4, is applied, the electrified amount distribution of the toner after passed through the electrifying roller becomes distribution of −5 μC/g on average, with the result that the toner includes the negative polarity toner, the reversal toner and the toner having improper electrified amount (less electrified amount). Similarly, when the triangular wave is applied, substantially the same result as that when the since wave of FIG. 4 is applied is obtained.

As such, the reason why the electrified amount distribution of the toner after passed through the electrifying roller 2 to which the alternating voltage having the sine or triangular wave form is applied is that includes the reversal toner and the toner having less electrified amount is that, in comparison with the triangular wave of the embodiment 1, regarding these wave forms, the time required for reaching the peak of the amplitude at the electrifying polarity reverse direction from the peak of the amplitude at the electrifying polarity direction side is shorter and the inclination of the rising portion at the electrifying polarity reverse direction side is steeper, with the result that it is apt to generate the reversal toner and the toner having improper electrified amount (less electrified amount) upon the electrifying.

### EMBODIMENT 2

Also in an embodiment 2 of the present invention, the image forming apparatus shown in FIG. 1 is used. In this embodiment, the recovering of the transferring residual toner in the developing process will be explained.

As mentioned above, the developing apparatus 4 is of cleaner-less type in which the transferring residual toner is cleaned simultaneously with the developing. As mentioned above, in this embodiment, the charged amount of the toner developed on the photosensitive drum 1 is −25 μC/g. Here, regarding developing conditions in this embodiment, a relationship to the electrified amount for recovering the transferring residual toner by the developing apparatus is shown in the following Table 2:

TABLE 2

| Electrified amount (μC/g) | Recovering ability |
|---|---|
| −10.0 | Poor |
| −12.5 | Good |
| −15.0 | Good |
| −30.0 | Good |
| −40.0 | Good |
| −45.0 | Good |
| −50.0 | Poor |

The toner electrified amount for recovering the transferring residual toner on the photosensitive drum 1 by the developing apparatus 4 is 0.5 to 1.8 times in comparison with the toner electrified amount times in comparison with the toner electrified amount upon the developing (−25 μC/g).

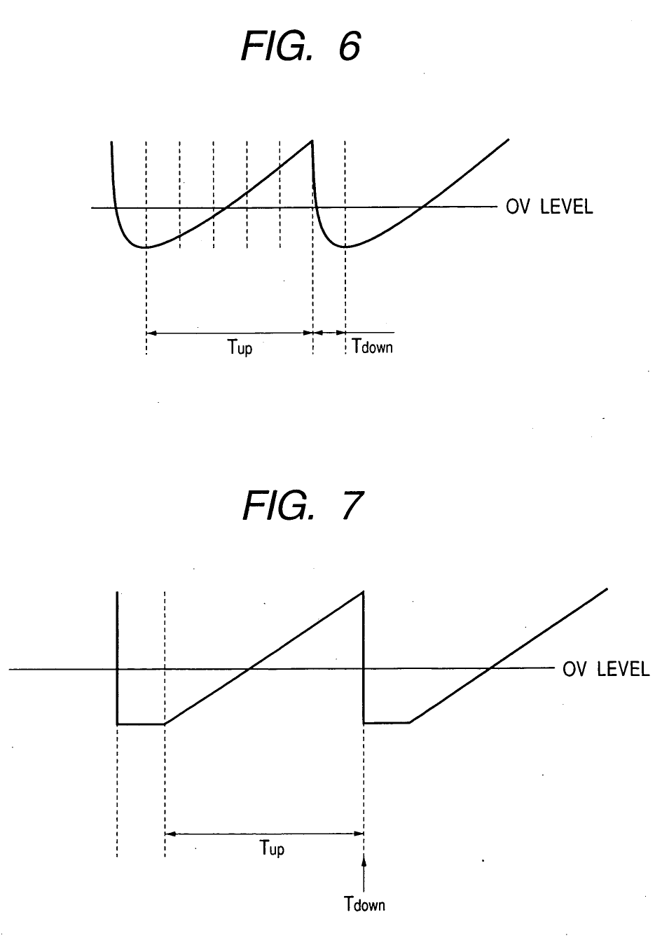

FIG. 6 is a wave form view of alternating voltage used in the embodiment 2. Similar to the embodiment 1, the rotational speed of the photosensitive drum 1 is 100 mm/sec, and the wave form is a curved wave having amplitude of 1,600 V, frequency of 1,150 Hz and duty ratio of 50%. This curved wave is a wave form having gentler inclination of the rising portion at the electrifying polarity reverse direction side than that of the triangular wave in the embodiment 1 and is increased in a curved fashion from the peak of the amplitude at the electrifying polarity direction side toward the peak of the amplitude at the electrifying polarity reverse direction side for a time corresponding to ⅚ of a wavelength. This time is greater, by 5 times, than the time of ⅙ of the wavelength required for returning to the peak of the amplitude at the electrifying polarity direction side from the peak of the amplitude at the electrifying polarity reverse direction side.

When the above-mentioned alternating voltage wave form is applied, the electrified amount distribution of the toner after passed through the electrifying roller 2 becomes sharp distribution of −25 μC/g on average, and distribution of the toner having less electrified amount is not found. This electrified amount is within a range of electrified amount, which can be recovered by the developing apparatus 4. In the embodiment 2 in which the alternating voltage having the wave shown in FIG. 6, since the inclination of the rising portion at the electrifying polarity reverse direction side is gentler in comparison with that in the embodiment 1, the reversal toner and the toner having improper electrified amount (less electrified amount) due to discharging at the electrifying polarity reverse direction side upon the electrifying are further reduced, thereby achieving the effect superior to that of the embodiment 1.

In this way, at the same time when the photosensitive drum 1 is electrified with the predetermined potential by means of the electrifying roller 2, the electrified amount of the transferring residual toner remaining on the photosensitive drum 1 and passed through the electrifying roller 2 is adjusted to the negative polarity, i.e. normal polarity and is controlled to be the proper electrified amount in which the electrostatic latent image on the photosensitive drum can be developed by the developing apparatus 4, with the result that the transferring residual toner is recovered by the developing apparatus efficiently. Thus, the image forming apparatus in which there is no poor electrifying and no poor image and merit of the cleaner-less system is utilized can be provided.
(Others)

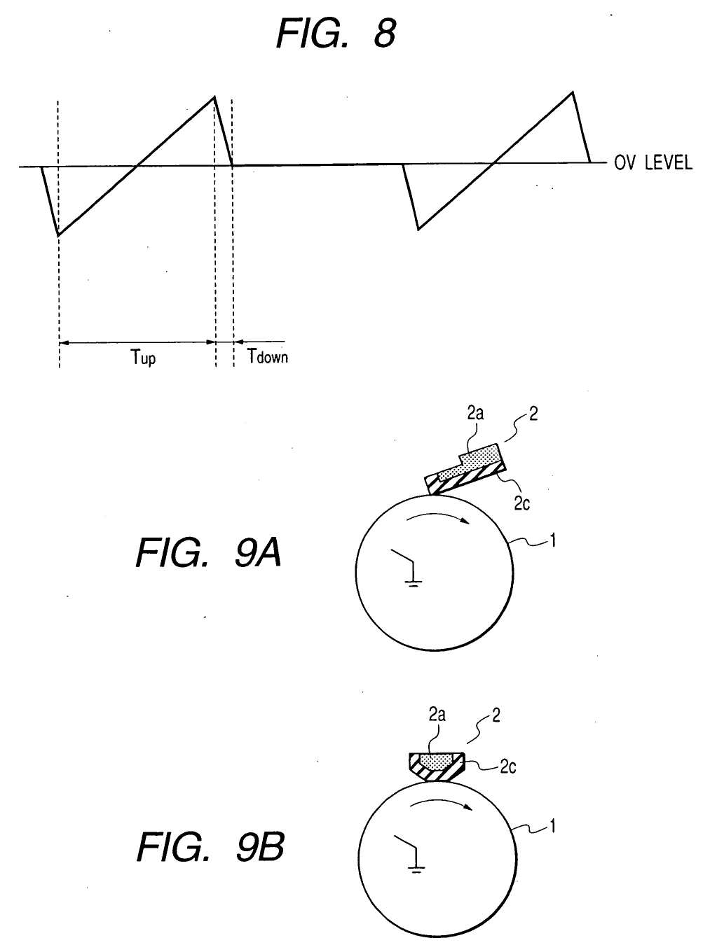

1) The present invention is not limited to the wave of the oscillation voltage in the above-mentioned embodiments. For example, the present invention is effective in a rectangular wave shown in FIG. 7 and is also effective in a blank pulse shown in FIG. 8 in which alternating voltage is turned ON and OFF periodically.

2) In the above-mentioned embodiments, while an example that the rotational speed of the photosensitive drum 1 is 100 mm/sec and the frequency of the alternating voltage is 1,150 Hz was explained, it should be noted that the present invention is effective in other settings.

3) The contact electrifying roller 2 is not limited to the roller, but, as shown in FIGS. 9A and 9B, a contact electrifying roller of blade type or block type or other type can be used. Also in these cases, the same effect as that of the roller type can be achieved. A magnetic brush electrifying member or a fur brush electrifying member may be used.

4) The electrifying roller as the contact electrifying member 2 is driven by the rotation of the photosensitive drum 1 as the image bearing member. Alternatively, the roller may be rotated independently in a direction same as or opposite to the rotational direction of the photosensitive drum. Or, the image bearing member may be fixed and the electrifying member may be shifted relative to the image bearing member.

5) The toner developing system and means for the electrostatic latent image is optional. That is to say, a reversal developing system or a normal developing system may be used.

6) The transferring means are not limited to the roller transferring means, but may be blade transferring, belt transferring or other contact transferring electrifying system, or a non-contact transferring electrifying system using a corona electrifier.

7) The present invention can be applied to not only the mono-color image forming apparatus but also a color image forming apparatus in which a multi-color or full-color image is formed by using multi-transferring performed by a transferring drum or a transferring belt.

8) Although it is desirable that the photosensitive member as the image bearing member has a low resistance layer having surface resistance of 10⁹ to 10¹⁴ Ω cm in view of realization of charge pouring electrifying and prevention of occurrence of ozone, an organic photosensitive member other than the above-mentioned one may be used. That is to say, the contact electrifying may be a charge pouring electrifying system or a contact electrifying system in which a discharging phenomenon is dominant.

9) The image forming process of the image forming apparatus is not limited to that in the embodiments but is optional. Further, if necessary, other auxiliary process equipment or equipments may be added.

10) The image exposing means for forming the electrostatic latent image are not limited to the laser scanning exposing means for forming the digital latent image as is in the embodiments, but may be a normal analogue image exposing means or other light emitting element such as an LED, or a combination of a light emitting element such as a fluorescent lamp and a liquid crystal shutter, so long as the electrostatic latent image corresponding to image information can be formed.

The image bearing member may be an electrostatic recording dielectric member. In this case, after a surface of the dielectric member is uniformly electrified with predetermined polarity and potential, a desired electrostatic latent image is written and formed by selectively removing electricity by electricity removing means such as an electricity-removing needle head or an electricity removing gun.

11) Any process equipments such as the image bearing member 1, electrifying apparatus 2, developing apparatus 4 and the like may be collectively incorporated into a process cartridge detachable with respect to a main body of the image forming apparatus.

As mentioned above, while the present invention has been described in connection with embodiments thereof, the present invention is not limited to such embodiments, but, various alterations can be made within the scope of the intention.

1. An image forming apparatus comprising:
an image bearing member for bearing an electro static image;
an electrifying member for contacting with said image bearing member to electrify said image bearing member;
voltage applying means for applying oscillation voltage to said electrifying member;
developing means for developing the electrostatic image on said image bearing member with toner to form a toner image;
transferring means for transferring the toner image on said image bearing member onto a transferring material;
and wherein
transferring residual toner on said image bearing member is recovered by said developing means after the toner is passed through an electrifying portion for said electrifying member;
and further wherein
said oscillation voltage applied to said electrifying member is characterized in that (i) a time required for shifting from an electrifying polarity side peak to a reverse side peak is longer than a time required for shifting the reverse side peak to the electrifying polarity side peak, and (ii) during a time required for shifting from an electrifying polarity side peak to a reverse side peak, a rate of change of said oscillation voltage to time becomes small as it approaches the electrifying polarity side peak.

2. An image forming apparatus according to claim 1,
wherein the time required for shifting from the reverse side peak to the electrifying polarity side is substantially zero.

3. An image forming apparatus according to claim 1,
wherein an electrified amount the transferring residual toner after passing through said electrifying portion is 0.5 to 1.8 times with respect to a toner electrifying amount upon developing.
